(19) United States
(12) Patent Application Publication
(10) Pub. No.: US 2012/0251865 A1
(43) Pub. Date: Oct. 4, 2012

(54) COOLING SHEET FOR AN ELECTROCHEMICAL CELL AND METHOD FOR CONNECTING A COOLING SHEET

(76) Inventors: Thomas HECKENBERGER, Leinfelden-Echterdingen (DE); Hans-Georg HERRMANN, Stuttgart (DE); Tobias ISERMEYER, Stuttgart (DE); Roman LORENZ, Ludwigsburg (DE); Michael MOSER, Rainau (DE)

(21) Appl. No.: 13/408,878

(22) Filed: Feb. 29, 2012

Related U.S. Application Data
(63) Continuation of application No. PCT/EP2010/062680, filed on Aug. 31, 2010.

(30) Foreign Application Priority Data
Aug. 31, 2009 (DE) 10 2009 039 394.3

(51) Int. Cl. F28F 7/00; H01M 10/50; B23P 19/04

(52) U.S. Cl. 429/120; 165/185; 29/525.01

(57) ABSTRACT

A heat sink for an electrochemical cell, the heat sink comprises a cell region which is designed to be coupled to the electrochemical cell, a connecting region which is designed to be connected mechanically and thermally to a cooling plate, and a fold region which is arranged between the cell region and the connecting region and comprises a flexible fold of the heat sink.

This nonprovisional application is a continuation of International Application No. PCT/EP2010/062680, which was filed on Aug. 31, 2010, and which claims priority to German Patent Application No. DE 10 2009 039 394.3, which was filed in Germany on Aug. 31, 2009, and which are both herein incorporated by reference.

### BACKGROUND OF THE INVENTION

1. Field of the Invention

The present invention relates to a cooling sheet for an electrochemical cell, a method for connecting a cooling sheet for an electrochemical cell to a cooling plate, and a cell device.

2. Description of the Background Art

There are various options for connecting a cell stack, particularly comprising lithium ion cells, with an integrated cooling element to a heat sink.

DE 10 2007 063 176 A1 describes possibilities for connecting the cooling sheet in different designs to a cooling plate.

DE 10 2007 066944.4 describes, inter alia, a cooling of flat battery cells, which have a cooling sheet as the thermal path. It is noted that the sheets are in thermal contact with the cooling plate; this contact is said to be produced by casting.

DE 102 23 782 B4, which corresponds to U.S. Pat. No. 7,531,269, describes a cooling device for round cells, comprising a base plate and cooling elements laterally abutting the cells in the longitudinal direction. The cells are connected to the cooling device in a force-fitting manner; the abutting cooling elements have expansion joints to improve the problem of gap formation and heat transfer.

The technology of the gluing or casting of cooling sheets onto a cooling plate does not have the desired permanency and process capability and the parts cannot be separated again. In other words, defective cells cannot be replaced.

Alternatively, cells or modules can be connected to the heat sink in a force-fitting manner. The heat transfer occurs from the cell body or cell casing directly to the heat sink or indirectly via cooling elements to the heat sink. To achieve a large contact surface and thereby good heat transfer, small fabrication tolerances, which result in a considerable expense, or very flexible elements are necessary.

An optimal heat transfer occurs across a material bonding connection. Current material bonding connections, however, are detrimental to the quality of the cell because of the high temperature input resulting from the fabrication process. Material bonding connections with a low temperature input, in contrast, can deteriorate or loosen because of dynamic stresses or can no longer be disassembled to replace defective cells.

### SUMMARY OF THE INVENTION

It is therefore an object of the present invention to provide an improved cooling sheet for an electrochemical cell, an improved method for connecting a cooling sheet, and an improved cell device.

The present invention is based on the fact that electrochemical cells, particularly Li ion cells, can be attached to a cooling sheet, which can be connected force-fittingly, by material bonding, or force-fittingly and by material bonding to a heat sink, e.g., a cooling plate through which a fluid flows. In this case, the design of the invention for the cooling sheet allows that a decoupling between the mechanical connection of the cooling sheet to the cooling plate and the thermal contacting between the cooling sheet and cooling plate can be realized by means of a fold region.

Advantageously, according to this approach, a thermally better contacting between the cooling sheet and cooling plate by the decoupling of a force-fitting connection and the thermal contacting can be achieved. In addition, the design makes it possible to avoid mechanical stress on the thermal contacting. Removability of the connection and thereby replacement of cells are also possible without a detrimental thermal effect on the cells. This applies in particular in the case of the force-fitting connection.

If the material bonding connection is realized, an optimal heat transfer via the material bonding connection is therefore present, without there being a negative thermal effect on the cell. According to the invention, because of the decoupling there is no mechanical stress on the material bonding connection. In the case of a material bonding connection as well, a force-fitting connection can be realized in addition.

The present invention provides a cooling sheet for an electrochemical cell having the following features: a cell region, which is designed to be coupled to the electrochemical cell; a connecting region, which is designed to be connected mechanically and thermally to a cooling plate; and a fold region, which is arranged between the cell region and the connecting region and comprises a flexible fold of the cooling sheet.

The cooling sheet can be a metal strip or a metal plate with good heat-conducting properties, so that it can conduct heat well away from the electrochemical cell. The material properties of the cooling sheet moreover can be designed so that the cooling sheet has, on the one hand, a necessary stability and strength to serve as support for the electrochemical cell. On the other hand, the cooling sheet can be reshaped with the application of force, to be provided with edges to match a correspondingly shaped recess or through opening in the cooling plate and thus to be attached to the cooling plate. The cooling sheet can be made as two parts over its entire length or over partial regions. This means that the cooling sheet is made up of, for example, two parallel metal sheets. The two metal sheets can be connected fixedly to one another, for example, in the cell region. In the fold region and in the connecting region, in contrast, the two metal sheets can be spaced apart.

The cell region of the cooling sheet can be understood to be a straight section of the cooling sheet to which the electrochemical cell can be attached. The electrochemical cell can be supported and cooled by the cell region. For example, the electrochemical cell can be glued onto the cell region of the cooling sheet. The cell region of the cooling sheet, however, can also be integrated into the electrochemical cell. Further, the cell region can be designed to take up two or more electrochemical cells.

The connecting region of the cooling sheet can be a section of the cooling sheet, which can be placed, e.g., in a through opening of the cooling plate. The connecting region can be reshaped during insertion or subsequently in such a way that the connecting region lies totally or at least partially within the through opening against the cooling plate. The mechanical and thermal connection between the cooling sheet and cooling plate can be formed by corresponding contact regions. The thermal connection results from the lying of the connecting region against the opening surface. Heat can be dissipated from the cooling sheet to the cooling plate via the thermal connection. The mechanical connection can be made force-fittingly and/or by material bonding. The force-fitting connection can be effected by a wedge which is inserted in the through opening and exerts a pressing force on the connecting region. In particular, the connecting region can be reshaped by the pressing force and thereby be adapted to a surface contour of the through opening. The material bonding connection can be achieved, e.g., by soldering of the connecting region to the opening surface of the cooling plate. The heat transfer can be improved further by the material bonding connection of the cooling sheet and cooling plate. In addition, the heat transfer can be improved by having the fold region abut a surface of the cooling plate.

The fold region can be formed by one or more folds, bends, or buckling of the metal strip. A lengthwise compensation of tolerances is possible because of the flexibility of the fold. This means that a length of the cooling sheet can be increased by pulling apart of the fold and reduced by a compression of the fold. Advantageously, the length of the cooling sheet can thereby be adjusted to a predefined distance between the cooling plate and an opposite support. The fold region can act as a spring.

According to an embodiment of the cooling sheet of the invention, at least the connecting region and the fold region each can have two spaced-apart, symmetrically arranged sections. According to said embodiment, thereby the metal strips of the cooling sheet can then divide at the cell region into two strands. The dividing can be in the form that the decoupling region is characterized by two legs which are folded in a mirror image outwardly and again inwardly and can be pressed together and pulled apart in each case with the application of force. Thus, the decoupling region can also function as a spring and provide corresponding restoring forces. Advantageously, this type of folding of the cooling sheet strip is technically simple to realize. The fold, on the one hand, can offer protection for a bottom side of the cell and, on the other, create a compensation region in the exposed region of the cooling sheet between the cell region and the connecting region. In the section of the connecting region, the two parts of the cooling sheet can be inserted in a through opening of the cooling plate. The two parts can abut the opposite wall regions of the through opening. Alternatively, the entire cooling sheet can also have two parts, whereby these are adjacent in the cell region section and can be connected to one another.

The present invention further provides a method for connecting a cooling sheet for an electrochemical cell to a cooling plate, whereby the method comprises the following steps: providing a cooling sheet of the invention; providing a cooling plate, whereby the cooling plate has a through opening for receiving the connecting region of the cooling sheet; inserting the connecting region of the cooling sheet into the through opening of the cooling plate, until the fold region of the cooling sheet comes to lie on the cooling plate; providing a pressing force, acting in the direction of the cooling plate on the cooling sheet, to fix the cooling sheet in the through opening of the cooling plate; and introducing a fastening element into the through opening of a cooling plate side, opposite to the fold region, to connect the connecting region of the cooling sheet force-fittingly to the cooling plate.

In the step of inserting the connecting region of the cooling sheet into the through opening, the fold region of the cooling sheet can be pressed together by the forces arising in the assembly process and form a resilient stop, so that the cooling sheet is slowed down during the insertion, on the one hand, and not inserted further into the through opening, on the other. Thus, the electrochemical cell can be protected from damage in that possible shocks during insertion can be absorbed and striking of the electrochemical cell against a surface of the cooling plate is prevented. Further, the fold region allows a greater tolerance range, which is to be maintained during the assembly of the cooling sheet, because the length of the cooling sheet after the assembly can be varied because of the flexible fold region. The fastening element advantageously can have a wedge shape. If the cooling sheet in the connecting region has two cooling sheet strips, thus the fastening element can be introduced easily between the two cooling sheet strips to create a force fit between the cooling sheet strips and the cooling plate.

A reshaping of the connecting region can also occur in the step of introducing the fastening element. Before the reshaping, the connecting region can have two parallel cooling sheet sections. The reshaping can bring about that the connecting region, therefore, for example, the two parallel cooling sheet sections, abuts an interior wall of the through opening. The reshaping can be achieved, for example, in that both the through opening and the fastening element have shapes corresponding to one another, for example, edges. Thus, the connecting region of the cooling sheet during introduction of the fastening element can be reshaped advantageously in such a way that the connecting region is connected form-fittingly to the cooling plate. In this way, in addition to the force-fitting connection, a form-fitting connection can be created, which enables an even more secure and more robust coupling of the cooling sheet to the cooling plate.

A step of removing the fastening element can occur after the step of introducing the fastening element. If there is only a force-fitting or form-fitting connection, after the removal of the fastening element the cooling sheet can be pulled easily out of the cooling plate. This is advantageous for removing a cooling sheet with a defective cell in a simple manner from the through opening, without adjacent cells being damaged.

A step of a material bonding connection of the connecting region and/or the fold region to the cooling plate can also occur after the step of removing the fastening element. The step of the material bonding connection can occur, e.g., via a welding or soldering process. Advantageously, by means of the material bonding connection the heat transfer from the cooling sheet to the cooling plate can be improved still further, compared with the force-fitting connection. In particular, in this case as well, the material bonding connection of the fold section region, lying on the cooling plate, creates an additional advantageous heat transfer surface.

According to an embodiment, in the step of the material bonding connection, the connection can be made by means of a thermal process with a low energy input. In this way, a negative thermal effect on the electrochemical cell can be avoided. For example, the cooling sheet can be connected to the cooling plate by means of laser soldering or soft soldering. Such connecting methods are of advantage to the effect that they can be performed with the saving of energy and less stress on the structure of the materials to be connected.

The present invention provides further a cell device having the following features: at least one cooling sheet of the invention; at least one electrochemical cell, which is coupled to the cell region of the at least one cooling sheet; and a cooling plate with at least one through opening for receiving the connecting region of the at least one cooling sheet, whereby the cooling plate in the region of the at least one through opening is connected mechanically and thermally to the connecting region of the at least one cooling sheet. The electrochemical cell can be made, e.g., as a lithium ion cell, which can be used for the power supply for devices with a high power requirement, e.g., electric and hybrid vehicles, often in a cell stack with a plurality of cells.

According to an embodiment, the through opening on a cooling plate side facing the fold region can have a smaller cross section than a cooling plate side facing away from the fold region. Advantageously, thus, a wedge-shaped fastening element, for example, can be easily inserted into the through opening and removed. In addition, because of the different cross section a form-fitting connection within the cooling plate is possible.

The cell device can also have the fastening element. The shape of the fastening element can correspond to a negative shape of the through opening. In this regard, the fastening element can be arranged in the through opening in such a way that the connecting region of the cooling sheet is connected force-fittingly to the region of the through opening of the cooling plate.

The fastening element can comprise a plastic or be made totally of plastic. Plastics have the advantage that they are cost-effective, have a low weight, and are suitable for producing the force-fitting connection between the cooling sheet and the cooling plate.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a sectional view of a cell device according to an exemplary embodiment of the present invention;

FIG. 2 shows another sectional view of a cell device according to an exemplary embodiment of the present invention;

FIG. 3 shows an enlarged partial view of the exemplary embodiment of a cell device of FIG. 2; and

FIG. 4 shows a method for connecting a cooling sheet for an electrochemical cell to a cooling plate, according to an exemplary embodiment of the invention.

### DETAILED DESCRIPTION

In the following description of the preferred exemplary embodiments of the present invention, the same or similar reference symbols are used for the elements with a similar action and shown in the different drawings, whereby a repeated description of these elements is omitted.

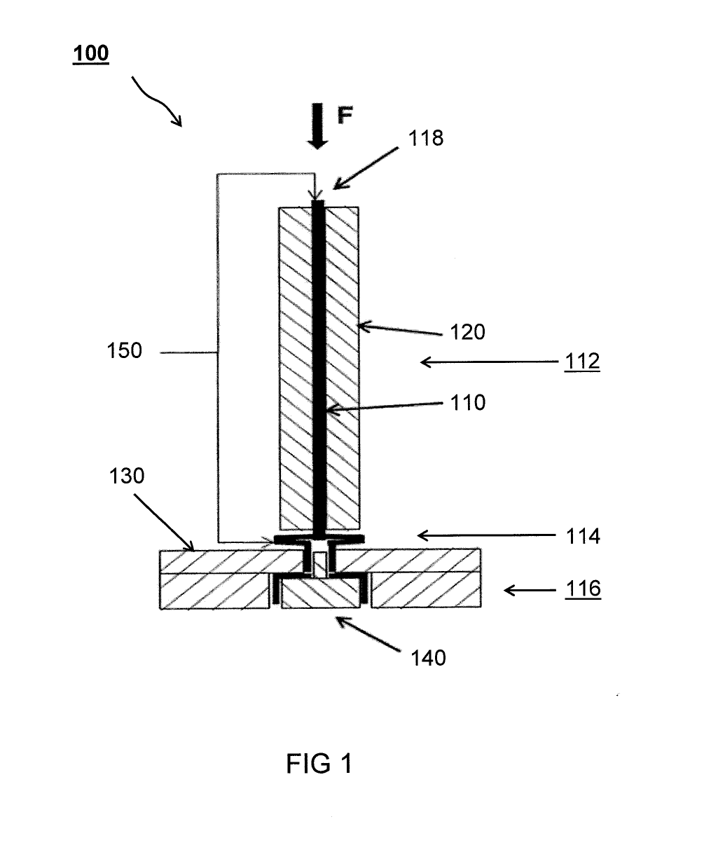

FIG. 1 shows a cell device 100 according to an exemplary embodiment of the present invention in a sectional view. Cell device 100 comprises a two-part cooling sheet 110 with a cell region 112, a fold region 114, and a connecting region 116. Further, cell device 100 comprises an electrochemical cell 120, a cooling plate or heat sink 130, and a fastening element 140. A bidirectional arrow 150 indicates a force-fitting connection between a pressure element 118 and fold region 114. Pressure region 118 can be formed by a free end of cell region 112, said end being opposite to cooling plate 130. A force F, which exerts a pressure on cooling sheet 110 in the direction of cooling plate 130, can act on pressure region 118.

In the exemplary embodiment shown in FIG. 1, cooling sheet 110 is formed straight in cell region 112 and coupled to electrochemical cell 120. Cell region 112 thus functions as a support and heat dissipator for cell 120. Cooling sheet 110 in cell region 112 can be a single part or can be two abutting parallel parts. Fold region 114 attaches to cell region 112. Fold region 114 has two spaced-apart sections, which are connected at one end to cell region 112 and at an opposite end to a section of the connecting region, which is made of two parts in this exemplary embodiment. Fold region 114 is characterized by a folding of the spaced-apart sections, in each case in the outward direction. The two sections thus form two legs folded in a mirror image outwardly and again inwardly. Each section thus runs obliquely in the direction of cooling plate 130, starting from the connection with cell region 112, then has the fold, and again runs obliquely in the direction of cooling plate 130 to a connection point with the corresponding section of the connecting region. The fold provides for the decoupling of the mechanical stress on the thermal contact. A part of cooling sheet 110, said part ending on the sides of cooling plate 130, is formed by connecting region 116. Here, cooling sheet 110 in the area of a through opening of cooling plate 130 is connected by means of fastening element 140 force-fittingly and/or by material bonding to cooling plate 130. Cooling plate 130 according to this exemplary embodiment has two layers. The through opening runs through both layers. In the layer facing cell 120, the through opening has a smaller diameter than in the layer facing away from cell 120. Both sections of the cooling sheet can be parallel during the insertion of connecting region 116 into the through opening. By means of the introduction of fastening element 140, because of the variable diameter of the through opening, the two sections can be shaped so that they abut an opposite wall region of the through opening.

Of course, cell device 100 may also have a plurality of electrochemical cells 120. The individual cells 120 are attached to cooling sheets 110. Cooling sheet 110 takes over the mechanical suspension of the cell and the thermal contacting, i.e., the cooling, and, as already mentioned, can have two parts. If cell device 100 has a plurality of cooling sheets 110, cooling plate 130 can have a through opening for each cooling sheet 110.

Therefore, FIG. 1 shows a structural design of cooling sheet 110 for a force-fitting connection with simultaneous decoupling of the mechanical stress on the thermal contacting. Cooling sheet 110 is positioned and fixed from above by means of pressing force F on cooling plate 130, and the force F is absorbed below by the folded region 114 of cooling sheet 110. Cooling sheet 110 penetrates cooling plate 130 and is reshaped from below with the aid of fastening element 140, placed against cooling plate 130, and thereby contacted thermally.

The force-fitting connection decouples the mechanical stress of the thermal connection between cooling sheet 110 and cooling plate 130. This results in a thermally better contacting and a removable connection between cooling sheet 110 and cooling plate 130. In addition, the heat transfer between cooling sheet 100 and cooling plate 130 cannot deteriorate due to mechanical stress. The connection can be removed again for the replacement of defective cells 120, without intact cells 120 being detrimentally affected thermally.

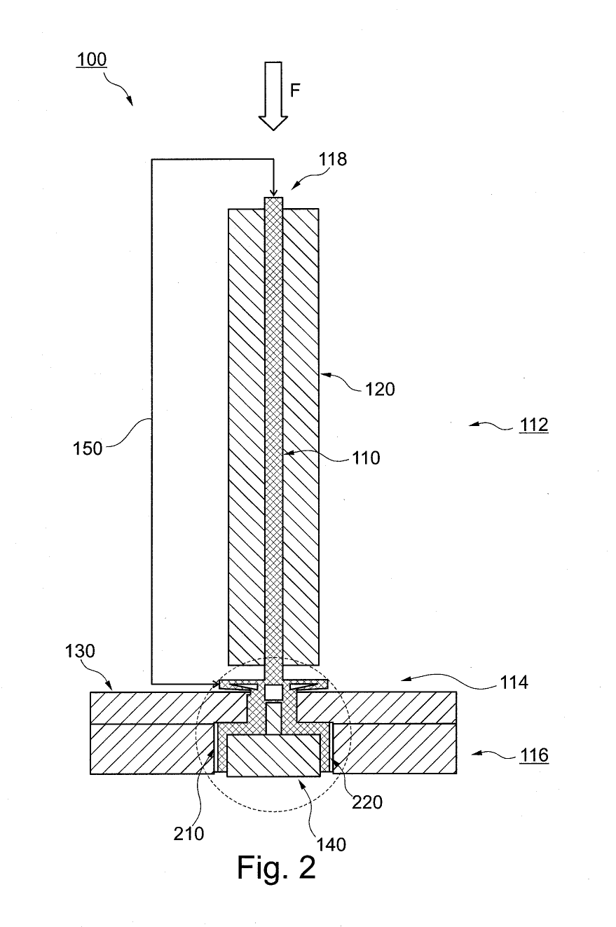

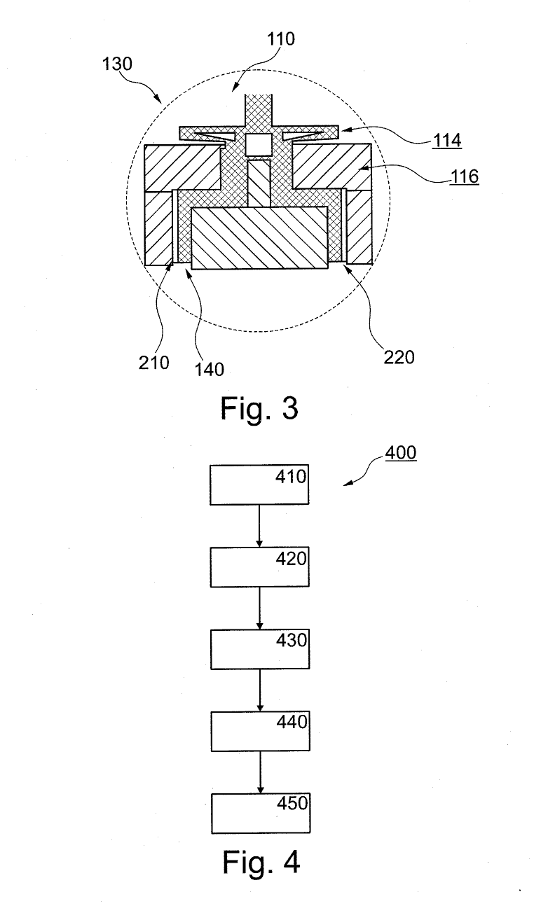

FIG. 2 shows the exemplary embodiment of cell device 100 of FIG. 1. In FIG. 2, cell device 100 has an additional material bonding connection 210, 220 in the region of the through opening of cooling plate 130. The material bonding connection can be present between cooling plate 130, on the one side, and connecting region 116 and/or fold region 114 of cooling sheet 110, on the other. This region of the material bonding connection is indicated in FIG. 2 by an interrupted circle and shown enlarged in FIG. 3.

FIG. 2 thus shows a structural design of cooling sheet 110 for a force-fitting connection according to the illustration of FIG. 1 with the simultaneous decoupling of the force fit and material bond. This design enables optimal heat transfer through the material bond between cooling sheet 110 and heat sink 130 by means of a thermal method with low energy input. A thermal method of this kind can be, e.g., laser soldering or soft soldering. The energy input can be dissipated via heat sink 130 during the assembly. In addition, there is the force-fitting connection for decoupling the material bonding connection from the mechanical stress according to the illustration in FIG. 1.

According to the illustration in FIG. 2, therefore, the material bonding connection between cooling sheet 110 and heat sink 130 can improve the heat transfer further. Because of the structure, a negative thermal effect on cell 120 during the material bonding is prevented. In addition, this connection decouples the force fit and material bond, as shown in FIG. 1, so that no mechanical stress can act on the material bonding connection and make the heat conduction worse as a result.

FIG. 3 shows an enlarged section of the region of cell device 100, which is emphasized in FIG. 2 by the interrupted circle and in which there is the material bonding connection between cooling sheet 110 and cooling plate 130. The two sections of connecting region 116 of cooling sheet 110 are pressed by means of fastening element 140 against the respective opposite surfaces of the through opening of cooling plate 130. After removal of fastening element 140 (not shown in FIG. 3), the adjacent surfaces of connecting region 116 and the through opening can be connected together, e.g., by material bonding by laser soldering, as indicated by the two arrows 210 and 220. In particular, the section of fold region 114, said section which lies on the cooling plate by means of pressing force F, can also be connected by the employed thermal method by material bonding to cooling plate 130. This can improve the heat transfer further. In this case, the leg of fold region 114, said leg opposite to cooling plate 130, can be oriented parallel to a surface of cooling plate 130. A lengthwise compensation of cooling sheet 110 can occur in this case via the other leg of fold region 114.

Finally, FIG. 4 shows a method 400 for connecting a cooling sheet for an electrochemical cell to a cooling plate, according to an exemplary embodiment of the invention. In this regard, this can relate to the cooling sheet, shown in the previous figures, having a cell region, a fold region, and a connecting region. The method 400 comprises a step of providing 410 the cooling sheet, another step of providing 420 the cooling plate, another step of inserting 430 the connecting region of the cooling sheet into the cooling plate, another step of providing 440 a pressing force on the cooling sheet, and finally a step of introducing 450 a fastening element into the cooling plate.

The cooling plate can have a through opening for receiving the connecting region of the cooling sheet. In step 430, the connecting region of the cooling sheet is inserted in the through opening of the cooling plate in such a way that the fold region of the cooling sheet comes to lie on the cooling plate. In so doing or afterwards, in step 440 a pressing force, acting in the direction of the cooling plate on the cooling sheet, is provided to fix the cooling sheet in the through opening of the cooling plate. Finally, in step 450, a fastening element is introduced from a cooling plate side, opposite to the fold region, in the through opening to connect the connecting region of the cooling sheet force-fittingly to the cooling plate.

The steps of method 400 can also be carried out in a sequence other than the one described. In addition, the described exemplary embodiments are selected only by way of example and can be combined with one another.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A cooling sheet for an electrochemical cell, the cooling sheet comprising:
a cell region configured to be coupled to the electrochemical cell;
a connecting region connectable mechanically and thermally to a cooling plate; and
a fold region arranged between the cell region and the connecting region, the fold region comprises a flexible fold of the cooling sheet.

2. The cooling sheet according to claim 1, wherein at least the connecting region and the fold region have two spaced-apart, symmetrically arranged sections.

3. A method for connecting a cooling sheet for an electrochemical cell to a cooling plate, the method comprising:
providing a cooling sheet according to claim 1;
providing a cooling plate that has a through opening for receiving the connecting region of the cooling sheet;
inserting the connecting region of the cooling sheet into the through opening of the cooling plate until the fold region of the cooling sheet comes to lie on the cooling plate;
providing a pressing force, which acts in a direction of the cooling plate, on the cooling sheet to fix the cooling sheet in the through opening of the cooling plate; and
introducing a fastening element into the through opening of a cooling plate side, opposite to the fold region, to connect the connecting region of the cooling sheet force-fittingly to the cooling plate.

4. The method according to claim 3, wherein, in the step of introducing the fastening element, a reshaping of the connecting region occurs in such a way that the connecting region abuts an interior wall of the through opening.

5. The method according to claim 3, wherein a step of removing the fastening element occurs after the step of introducing the fastening element.

6. The method according to claim 5, wherein a step of a material bonding connection of the connecting region and/or the fold region to the cooling plate occurs after the step of removing the fastening element.

7. The method according to claim 6, wherein, in the step of the material bonding connection, the connection is made via a thermal process with a low energy input to avoid a negative thermal effect on the electrochemical cell.

8. A cell device comprising:
at least one cooling sheet according to claim 1;
at least one electrochemical cell, which is coupled to the cell region of the at least one cooling sheet; and
a cooling plate having at least one through opening for receiving the connecting region of the at least one cooling sheet, the cooling plate in the region of the at least one through opening being connectable mechanically and thermally to the connecting region of the at least one cooling sheet.

9. The cell device according to claim 8, wherein the through opening on a side of the cooling plate, the side facing the fold region, has a smaller cross section than a side of the cooling plate, said side facing away from the fold region.

10. The cell device according to claim 8, wherein the cell device has a fastening element, whose shape corresponds to a negative shape of the through opening, and whereby the fastening element is arranged in the through opening in such a way that the connecting region of the cooling sheet is connected force-fittingly with the region of the through opening of the cooling plate.

11. The cell device according to claim 8, wherein the fastening element comprises a plastic.
